(19) United States
(12) Patent Application Publication
(10) Pub. No.: US 2014/0223161 A1
(43) Pub. Date: Aug. 7, 2014

(54) ELECTRONIC DEVICE AND BOOTING METHOD THEREOF

(71) Applicant: SAMSUNG ELECTRONICS CO., LTD., Suwon-si (KR)

(72) Inventor: Hyoung-su KIM, Gunpo-si (KR)

(73) Assignee: SAMSUNG ELECTRONICS CO., LTD., Suwon-si (KR)

(21) Appl. No.: 14/133,930

(22) Filed: Dec. 19, 2013

(30) Foreign Application Priority Data
Feb. 1, 2013 (KR) 10-2013-0011686

(51) Int. Cl. G06F 9/44; G06F 1/04; G06F 1/24

(52) U.S. Cl. CPC G06F 9/4401; G06F 1/24; G06F 1/04
USPC 713/2

(57) ABSTRACT

An electronic device includes: a clock divider configured to divide a received main clock signal and generate a plurality of divided clock signals; a storage configured to store booting data; and a controller which, upon supply of power, is configured to generate the main clock signal and output the main clock signal to the clock divider, and output a control signal to read the booting data based on the divided clock signals after a predetermine time for stabilizing the divided clock signals has elapsed.

### CROSS-REFERENCE TO RELATED APPLICATION

This application claims priority from Korean Patent Application No. 10-2013-0011686, filed on February 1, 2013 in the Korean Intellectual Property Office, the disclosure of which is incorporated herein by reference in its entirety.

### BACKGROUND

1. Field

Apparatuses and methods consistent with the exemplary embodiments relate to an electronic device and a booting method thereof, and more particularly, to an electronic device and a booting method thereof which includes a clock division.

2. Description of the Related Art

Electronic devices, such as Television (TVs), home appliances and various mobile terminals, perform a booting process if they receive power and a driving signal. If the booting process is started, a main controller, such as a central processing unit (CPU), generates a clock signal, which is a basis for driving chips, modules and devices of the electronic devices.

In many cases, the clock signal may have errors after power is supplied and before components of the electronic device are stabilized. In particular, an error may occur if a clock signal is divided into a plurality of clock signals. If the clock signal has the error, it results in an error in driving the electronic device and the booting process is not performed.

If the electronic device is driven in a non-safety mode, the electronic device attempts to perform a booting process until the booting process is successfully performed. That is, the electronic apparatus may successfully perform the booting process only when the clock signal is stabilized. However, if the electronic device is driven in a safety mode, the electronic device attempts to perform the booting process only a preset number. If the booting process attempted by the preset number ends in failure, the electronic device is not driven at all. Accordingly, there exists a need for a method of providing a stable clock signal.

### SUMMARY

Aspects of one or more exemplary embodiments provide an electronic device and a booting method thereof which may perform a normal booting process even upon occurrence of an error when a clock signal is divided.

Another exemplary embodiment is to provide an electronic device and a booting method thereof which may be safely booted even in a safety mode in which performance of an operation is suspended upon failure of a booting process.

Another exemplary embodiment is to provide a display apparatus and a software recovery method which selectively recovers software only when particular conditions are satisfied.

According to an aspect of an exemplary embodiment, there is provided an electronic device including: a clock division configured to divide a received main clock signal and generate a plurality of divided clock signals; a storage configured to store booting data; and a controller, upon supply of power, configured to generate the main clock signal and output the main clock signal to the clock division, and output a control signal to read booting data based on the divided clock signals to the storage after a predetermined time for stabilizing the divided clock signals has elapsed.

The control signal may include a reset signal and a chip select signal.

The predetermined time may include hundreds of milliseconds (ms) after the power is supplied.

The controller is configured to enter a safety mode in which a booting process is suspended if the booting process to read the booting data ends in failure after a preset number of attempts.

The electronic device may further include a broadcasting receiver configured to receive a broadcasting signal.

According to an aspect of another exemplary embodiment, there is provided a booting method of an electronic device comprising a clock division to divide a received main clock signal to a plurality of divided clock signals, the booting method including: generating the main clock signal and outputting the main clock signal to the clock division upon supply of power; outputting, a control signal to read booting data based on the divided clock signals to a storage after a predetermined time for stabilizing the divided clock signals has elapsed; and reading the booting data and performing a booting process.

The booting method may further include entering a safety mode in which the booting process is suspended if the booting process for reading the booting data ends in failure after a preset number of attempts.

According to an aspect of another exemplary embodiment, there is provided an electronic device including: a clock divider configured to divide a received main clock signal to a plurality of divided clock signals; a storage configured to store booting data; and a controller, upon supply of power, configured to generate the main clock signal, output the main clock signal to the clock divider after a predetermined time for stabilizing the clock division has elapsed, and output a control signal to read booting data based on the divided clock signals to the storage.

### BRIEF DESCRIPTION OF THE DRAWINGS

The above and other aspects will become apparent and more readily appreciated from the following description of the exemplary embodiments with reference to the accompanying drawings, in which:

FIG. 1 is a control block diagram of an electronic device according to an exemplaryembodiment;

FIG. 2A illustrates a signal waveform of a related artelectronic device to explain a booting process of the electronic device;

FIG. 2B illustrates a signal waveform to explain the booting process of the electronic device according to an exemplaryembodiment; and

FIG. 3 is a control flowchart to explain the booting process of the electronic device according to an exemplary embodiment.

### DETAILED DESCRIPTION OF EXEMPLARY EMBODIMENTS

Exemplary embodiments will be described in detail with reference to accompanying drawings. The exemplary embodiments may be embodied in various forms without being limited to the exemplary embodiments set forth herein. Descriptions of well-known parts are omitted for clarity, and like reference numerals refer to like elements throughout.

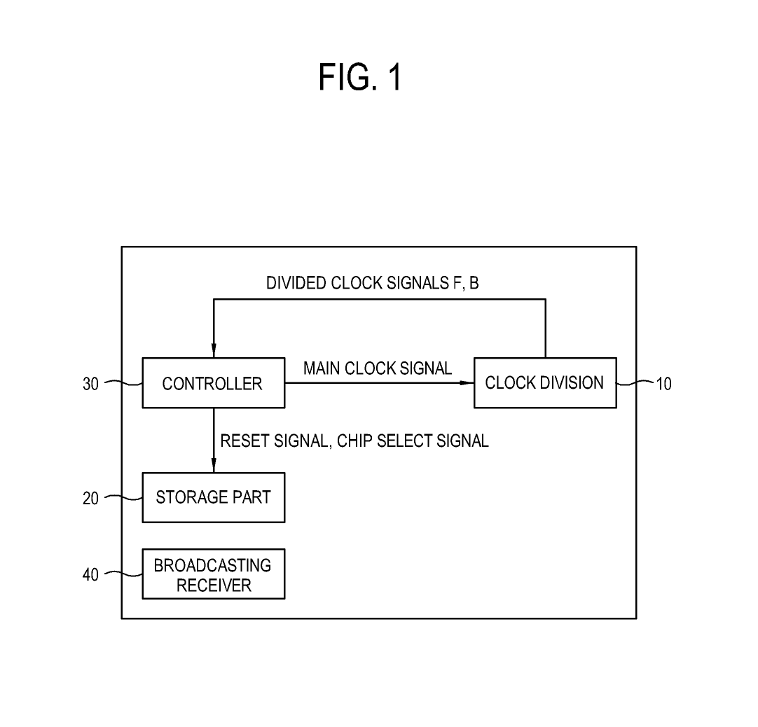

FIG. 1 is a control block diagram of an electronic device according to an exemplaryembodiment. The electronic device according to the exemplaryembodiment may include any device including a clock division 10 receiving a main clock signal and dividing the main clock signal into a plurality of divided clock signals. The electronic device may include a television, a set-top box, a computer system and other various home appliances. The electronic device includes a clock division 10, a storage 20, a controller 30 controlling the foregoing elements and booting the electronic device, and a broadcasting receiver 40 receiving a broadcasting signal. The electronic device according to the exemplaryembodiment may be implemented as a TV or a set-top box which receives a broadcasting signal.

The clock division 10 may be implemented as a clock buffer which receives a main clock signal from the controller 30 and divides the main clock signal into a plurality of divided clock signals. The plurality of divided clock signals is input to other devices, i.e. other chips, such as graphic cards or modules. The divided clock signals mean the main clock signal that is divided into a plurality of clock signals. The divided clock signals have the same frequency as the main clock signal does, and act as a basis for transmitting and receiving all signals driving the electronic device. If a clock signal divided by the clock division 10 is unstable and thus does not have a consistent frequency or waveform of the clock signal has an error, the driving of the electronic device may have an error, and the booting of the electronic device may end in failure.

The storage 20 stores booting data. For example, the storage 20 stores data, such as an operating system (OS) of the electronic device, and upon supplying of power to the electronic device, the data stored in the storage 20 is read and the booting process is started. The booting data according to the exemplary embodiment means any data read or loaded by the controller 30 to perform the booting process. The storage 20 may be implemented as a flash memory storing the booting data. Checking hardware and software and loading data, which are incidental to the booting process, are well-known technology, and thus will not be described herein.

The controller 30 may be implemented as a CPU or a main decoder integrated circuit (IC). If power is supplied to the electronic device, the controller 30 generates a main clock signal and outputs the main clock signal to the clock divider 10, and receives divided clock signals from the clock divider 10. The controller 30 outputs various control signals to perform the booting process based on the divided clock signals by the clock divider 10. The control signal may include a reset signal and a chip select signal output by the controller 30. All signals output by the controller 30 are based on the divided clock signals. Thus, a divided clock signal should be a stable and normal condition to access the storage 20. When the controller 30 determines that the divided clock signals divided by the clock divider 10 and the main clock signal initially generated by the controller 30 are the same, the controller 30 reads the booting data stored in the storage 20. However, the divided clock signals may have an error when the divided clock signals are initially divided.

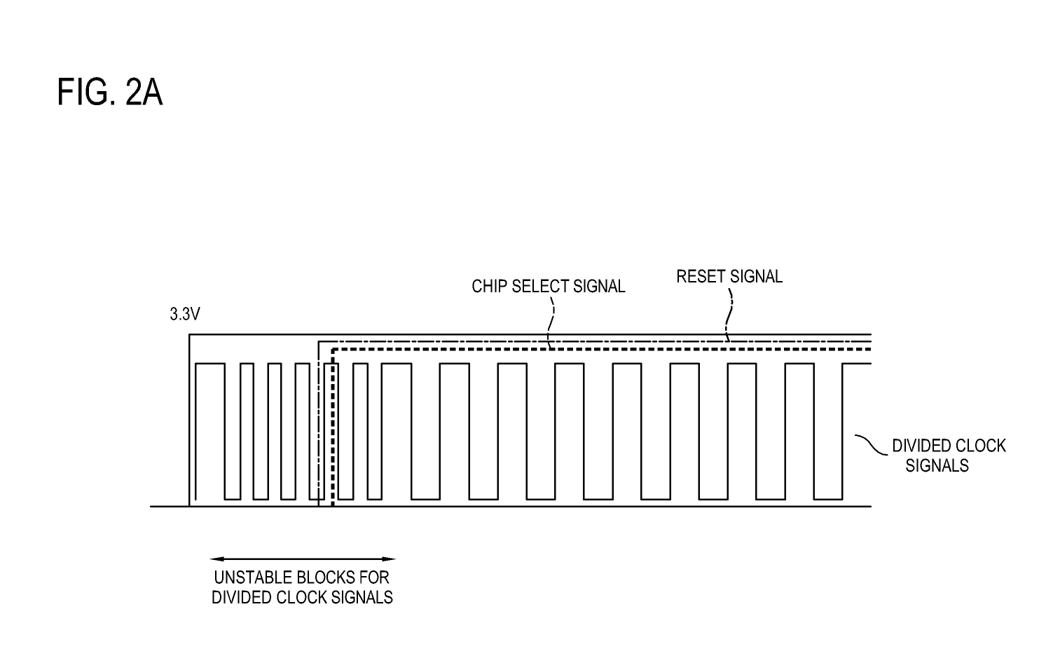

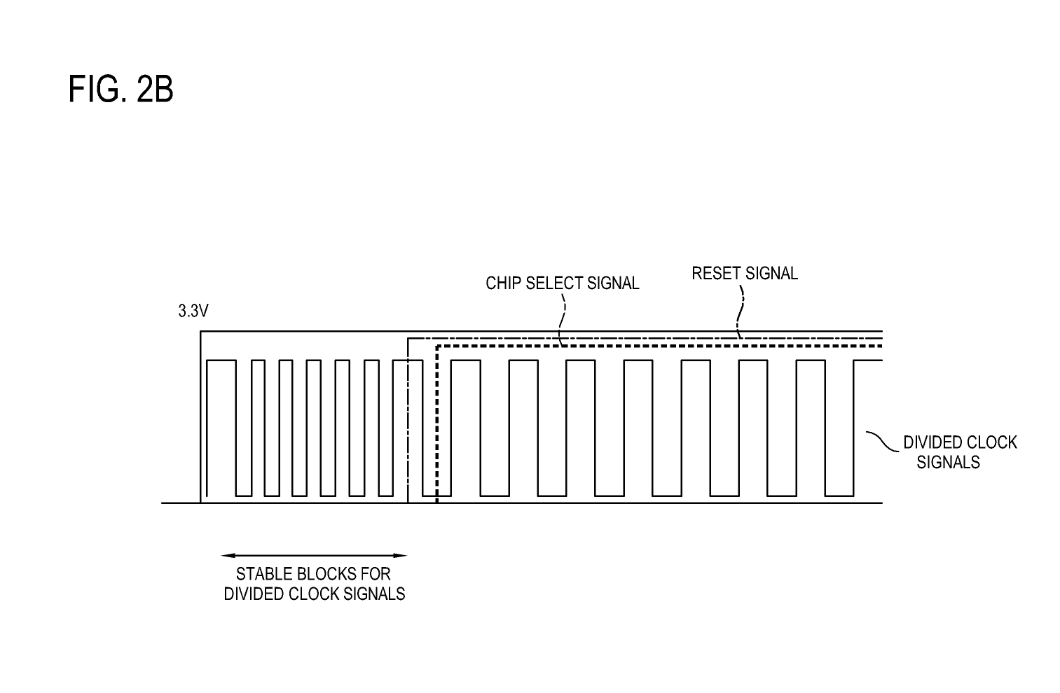

FIG. 2A illustrates a signal waveform of a related art electronic device to explain the booting process of the electronic device when the divided clock signals have an error. As shown in FIG. 2A, the divided clock signals generated from a couple of usec to hundreds of msec after power is supplied to the electronic device do not have consistent waveform and vary in frequency. For example, if a main clock signal has a frequency of 33 Mhz, the divided clock signals should have a frequency of 33 Mhz. However, there is a possibility that all of the chips or circuits are not stabilized when power is initially supplied to the electronic device, and certain time may be needed to stabilize the chips or circuits. The divided clock signals generated during the unstable time may have an error. In this state, i.e., the divided clock signals are not stable, if the controller 30 outputs a reset signal or chip select signal to access the storage 20, the access to the storage 20 ends in failure and the booting process is not performed. That is, upon occurrence of a timing error, the access to the storage 20 ends in failure and the storage 20 is not reset and the process to read or write the data stored in the storage 20 is not performed.

If the access to the storage 20 is failed and the booting process ends in failure, the electronic device may operate in either a non-safety mode in which the electronic device continuously attempts to perform the booting process, or a safety mode in which the electronic device suspends an operation upon failure of the booting process. If the electronic device operates in the non-safety mode, a user feels that the booting time is long, since the booting process is performed when the electronic device attempts the booting process at the time when the divided clock signals are stabilized. However, in the case of the safety mode, if the booting attempts end in failure more times than a preset numbers, the electronic device is not booted. That is, in the safety mode, if the electronic device continuously attempts to perform the booting process during the unstable period of the divided clock signals and fails to perform the booting process, the electronic device is not booted.

Accordingly, the controller 30 according to the exemplary embodiment outputs a control signal to the storage 20 to read the booting data based on the divided clock signals if a predetermined time for stabilizing the divided clock signals has elapsed after the divided clock signals are provided. FIG. 2B illustrates a signal waveform to explain the booting process of the electronic device according to the exemplary embodiment. As shown in FIG. 2B, the controller 30 outputs a reset signal and a chip select signal to the storage 20 hundreds of msec after a stabilization period, during which the divided clock signals have the same frequency as the main clock signal does, has elapsed. As the control signal is output after the divided clock signals are stabilized, the controller 30 may successfully access the storage 20. After the storage 20 performs to reading or writing of the data according to the reset signal and the chip select signal, the normal booting process is performed.

A strap pin to which a plurality of resistors is connected to delay time may be used. If the resistors receive power or are connected to the ground to output high or low value, such a combination may produce a certain value. The controller 30 may interpret the output value, and reset or adjust the output timing of the control signal. A circuit concerning time delay may employ an analog or a digital circuit and is not limited to a certain type.

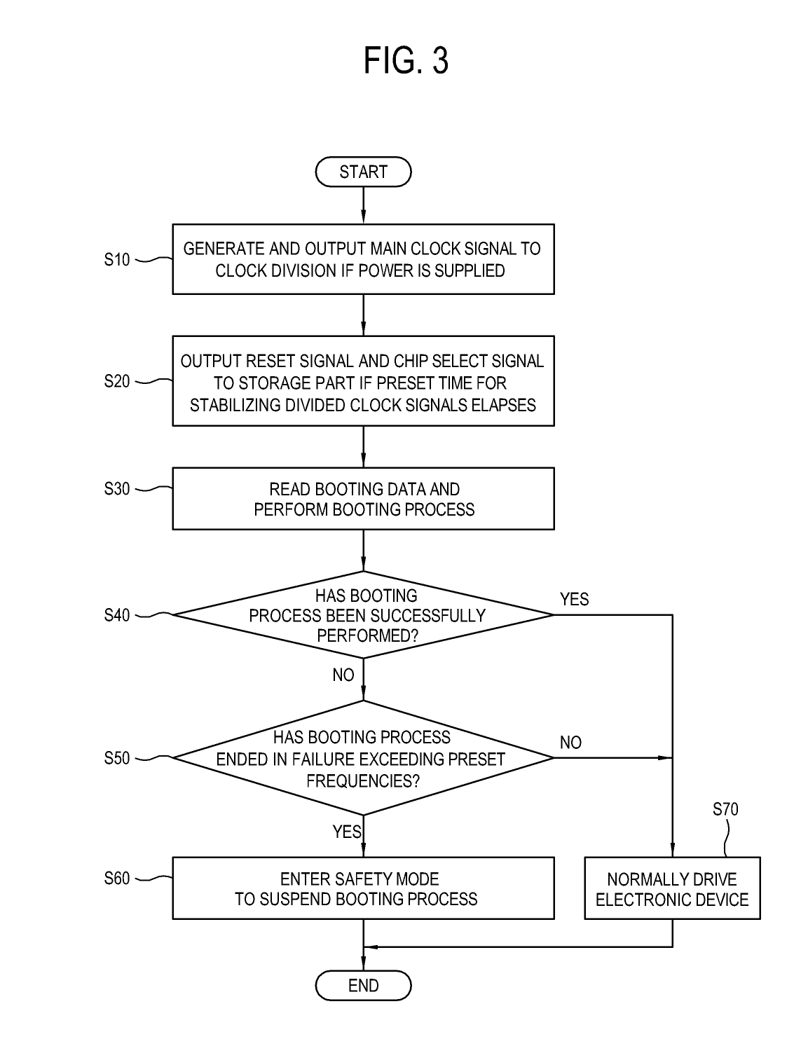

FIG. 3 is a control flowchart to explain the booting process of the electronic device according to the exemplary embodiment.

If power is supplied, the controller 30 generates the main clock signal and outputs the main clock signal to the clock division 10 (S10).

The controller 30 receives divided clock signals generated by the clock division 10, outputs various control signals and performs the booting process based on the divided clock signals. After receiving the divided clock signals, the controller 30 outputs the control signals, i.e., a reset signal and a chip select signal, to the storage 20 to read the booting data after a predetermined time for stabilizing the divided clock signals has elapsed. For example, the controller 30 outputs the reset signal to the storage 20 approximately hundreds of msec after power is supplied to the electronic device (S20).

According to another exemplary embodiment, after power is supplied and a predetermined time for stabilizing the clock division 10 and storage 20 has elapsed, the controller 30 may output the main clock signal to the clock division 10. That is, the controller 30 may output the control signal by avoiding any unstable divided clock signal, and generate a main clock signal after a predetermined time for stabilizing entire devices has elapsed.

If it is ready to read the booting data of the storage 20 according to the control signal, the controller 30 accesses to the storage 20, reads the booting data from the storage 20, and performs the booting process (S30).

If the electronic device is successfully booted (S40), the electronic device is normally operated (S70).

If the controller 30 fails to access the storage 20 and fails to perform the booting process (S40), the controller 30 attempts to access the storage part 20 a preset number of times. If the attempts to perform the booting process end in failure exceeding the preset number (S50), the controller 30 enters the safety mode in which the booting process is suspended (S60). Typically, the preset number is set to three or five. If the electronic device enters the safety mode, the controller 30 may provide a user with a graphic user interface (GUI) showing that the booting has not been successfully performed, or a GUI inducing a user to reset power or a GUI showing contact information of a service center to settle the problem of the electronic device.

If the booting process is successfully performed within the preset number of times, the electronic device is normally operated after the booting process is completed (S70).

Although a few exemplary embodiments have been shown and described, it will be appreciated by those skilled in the art that changes may be made in these exemplary embodiments without departing from the principles and spirit of the inventive concept, the range of which is defined in the appended claims and their equivalents.

What is claimed is:

1. An electronic device comprising:
a clock divider configured to receive a main clock signal and divide the received main clock signal and generate a plurality of divided clock signals;
a storage configured to store booting data; and
a controller which, upon supply of power, is configured to generate the main clock signal and output the main clock signal to the clock divider, and output a control signal to read the booting data based on the divided clock signals to the storage after a predetermined time for stabilizing the divided clock signals has elapsed.

2. The electronic device according to claim 1, wherein the control signal comprises a reset signal and a chip select signal.

3. The electronic device according to claim 1, wherein the predetermined time comprises hundreds of msec after the power is supplied.

4. The electronic device according to claim 1, wherein if a booting process to read the booting data ends in failure after a preset number of attempts, the controller enters a safety mode in which the booting process is suspended.

5. The electronic device according to claim 4, wherein the preset number of attempts is one of three and five.

6. The electronic device according to claim 1, further comprising a broadcasting receiver configured to receive a broadcasting signal.

7. A booting method of an electronic device comprising a clock divider to divide a received main clock signal to a plurality of divided clock signals, the booting method comprising:
generating by a controller the main clock signal and outputting the main clock signal to the clock divider upon supply of power;
outputting to a storage a control signal to read booting data based on the divided clock signals after a predetermined time for stabilizing the divided clock signals has elapsed; and
reading the booting data and performing a booting process.

8. The booting method according to claim 7, wherein the control signal comprises a reset signal and a chip select signal.

9. The booting method according to claim 7, wherein the predetermined time comprises hundreds of msec after the power is supplied.

10. The booting method according to claim 7, further comprising entering a safety mode in which the booting process is suspended if the booting process to read the booting data ends in failure after a preset number of attempts.

11. The booting method according to claim 10, wherein the preset number of attempts is one of three and five.

12. An electronic device comprising:
a clock divider configured to divide a received main clock signal to a plurality of divided clock signals;
a storage configured to store booting data; and
a controller, upon supply of power, configured to generate the main clock signal, output the main clock signal to the clock divider after a predetermined time for stabilizing the clock division has elapsed, and output a control signal to read the booting data based on the divided clock signals to the storage.

13. The electronic device according to claim 12, wherein the predetermined time comprises hundreds of msec after the power is supplied.

14. The electronic device according to claim 12, wherein if a booting process to read the booting data ends in failure after a preset number of attempts, the controller enters a safety mode in which the booting process is suspended.

15. The electronic device according to claim 14, wherein the preset number of attempts is one of three and five.
